(19) United States
(12) Patent Application Publication
(10) Pub. No.: US 2015/0113804 A1
(43) Pub. Date: Apr. 30, 2015

(54) WIRE STRIP AND CRIMP TOOL

(71) Applicant: General Electric Company, Schenectady, NY (US)

(72) Inventors: Adam Eric Virkler, Erie, CO (US); Steven Jackson Foss, Loveland, CO (US); Aaron Isaac Katz, Grand Junction, CO (US); Jeffrey Marcus Pitts, Lakewood, CO (US); Robert Allen Linden, Westminster, CO (US); Anthony Thomas Concialdi, Parker, CO (US); Sean Ray Ortiz, Boulder, CO (US); Aaron Juergen Fuss, Denver, CO (US)

(73) Assignee: General Electric Company, Schenectady, NY (US)

(21) Appl. No.: 14/066,500

(22) Filed: Oct. 29, 2013

(51) Int. Cl. H01R 43/042; H01R 43/045; H02G 1/12

(52) U.S. Cl. CPC H01R 43/0421; H02G 1/1212; H01R 43/045
USPC 29/867; 7/107

(57) ABSTRACT

A system includes a tool having a first arm disposed along a motion plane, a hand-tool body coupled to the first arm, and a second arm rotatably coupled to the hand-tool body and disposed along the motion plane. The hand-tool body includes a first channel, a second channel, and a wire slot configured to receive an insulated wire, wherein the first channel intersects the second channel proximate to the wire slot. The second arm includes a stripping portion configured to reciprocate within the first channel, to cut insulation of the insulated wire, and to strip the insulation from an end portion of the insulated wire. The second arm also includes a crimping portion configured to reciprocate within the second channel and to crimp a terminal lug about the end portion of the insulated wire.

### BACKGROUND

The subject matter disclosed herein relates to a hand-tool, and more specifically, a wire strip and crimp hand-tool.

Wires of various sizes carry electrical signals for power and communications. Wire insulation helps to isolate wires from environmental conditions that may affect the carried signals. Insulation also isolates carried current from other conductors that may contact the wire. Terminal lugs mechanically attached to ends of a wire interface the wire with electrical components, enabling signal transmission between the wire and the electrical components. The insulation at the ends of the wire may be removed to provide a desired electrical interface between the terminal and the wire. Some systems may be automated to place terminal lugs on wires; however, such systems may be relatively large, may require an external power source, and/or may not be readily used and carried by an operator. Improper sizing with manual wire strippers may cut into the conductor surface, which may decrease the quality of the interface with the terminal lug. Separate manual crimpers require additional steps to crimp the terminal lug after stripping the wire. Moreover, carrying a manual wire stripper and a manual crimper may be cumbersome.

### BRIEF DESCRIPTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a tool having a hand-tool body, a stripping portion, and a crimping portion. The hand-tool body includes a wire slot, a first channel, and a second channel that are within a motion plane and that intersect at a process area. The wire slot is configured to receive an insulated wire. The stripping portion is arranged within the first channel and is configured to reciprocate along the first channel to strip insulation from an end portion of the insulated wire. The crimping portion is coupled to the stripping portion and is arranged within the second channel. The crimping portion is configured to reciprocate along the second channel to crimp a terminal lug about at least part of the end portion of the insulated wire. The reciprocation of the stripping portion along the first channel relative to the process area is substantially opposite to the reciprocation of the crimping portion along the second channel.

In a second embodiment, a system includes a tool having a first arm disposed along a motion plane, a hand-tool body coupled to the first arm, and a second arm rotatably coupled to the hand-tool body and disposed along the motion plane. The hand-tool body includes a first channel, a second channel, and a wire slot configured to receive an insulated wire, wherein the first channel intersects the second channel proximate to the wire slot. The second arm includes a stripping portion configured to reciprocate within the first channel, to cut the insulation of the insulated wire, and to strip the insulation from an end portion of the insulated wire. The second arm also includes a crimping portion configured to reciprocate within the second channel and to crimp a terminal lug about the end portion of the insulated wire.

In a third embodiment, a method includes rotating a second arm of a hand-tool relative to a first arm of the hand-tool from a first position to a second position within a motion plane, cutting insulation from an end of an insulated wire with a stripping portion of the hand-tool, removing insulation from the end of the insulated wire with the stripping portion of the hand-tool, arranging a terminal lug about the end of the insulated wire, and crimping the terminal lug about the end of the insulated wire with a crimping portion of the hand-tool. The stripping portion is actuated along the motion plane by the second arm to remove insulation, and the crimping portion is actuated along the motion plane by the second arm.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic of an embodiment of various wires and terminal lugs that may be joined by a strip/crimp hand-tool to couple the wires with respective terminals of an electrical system;

FIG. 2 is a perspective view of an embodiment of the strip/crimp hand-tool;

FIG. 3 is a perspective view of an embodiment of a stripping portion of the strip/crimp hand-tool;

FIG. 4 is a front view of an embodiment of a hand-tool body of the strip/crimp hand-tool;

FIG. 5 is a perspective view of an embodiment of a lug loading system of the strip/crimp hand-tool;

FIG. 6 is a perspective view of an embodiment of the crimping portion, a terminal lug, and a stripped wire end portion; and

FIG. 7 is an embodiment of a method for operating the strip/crimp hand-tool.

### DETAILED DESCRIPTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

A strip/crimp hand-tool as described herein is a hand-tool that strips an end portion of an insulated wire and crimps a terminal lug thereto. The strip/crimp hand-tool is a hand-tool that may be readily carried by an operator and used in a variety of environments. Embodiments of the strip/crimp hand-tool described herein include a manually driven system; however some embodiments of the strip/crimp hand-tool may include one or more components driven by an electric drive system, a pneumatic system, a hydraulic system, or a spring-loaded system. The strip/crimp hand-tool may utilize substantially one motion by the operator (e.g., opening or closing arms relative to one another) to cut the insulation at an end of a wire, strip the insulation from the end of the wire, and crimp a terminal lug about at least a portion of the exposed end of the wire. A stripping portion cuts the insulation and removes the insulation from the wire. In some embodiments, the strip/crimp hand-tool cuts the insulation to a cut depth based at least in part on a size of the wire, which may be determined by the strip/crimp hand-tool. The stripping portion may actuate (e.g., reciprocate) along a first axis within a first channel of the strip/crimp hand-tool. The crimping portion may actuate (e.g., reciprocate) along a second axis within a second channel of the strip/crimp hand-tool. The stripping portion and crimping portion may be coupled to an adjustable member (e.g., arm, turnkey, knob) controlled by the operator to control the cutting, stripping, and crimping actions in substantially one operator motion. In some embodiments, the operator motion may be substantially within the same motion plane as the reciprocating stripping portion and the reciprocating crimping portion. In some embodiments, a separate operator motion (e.g., actuating a cutting lever) may cut the insulation. The terminal lug may be manually placed about the exposed wire end or placed about the exposed wire end by a lug loading system. The lug loading system may include a lug magazine configured to automatically reload another terminal lug after placement of a terminal lug, thereby enabling an operator to strip multiple wire ends and to crimp multiple terminal lugs without manually reloading the terminal lug after each crimping action.

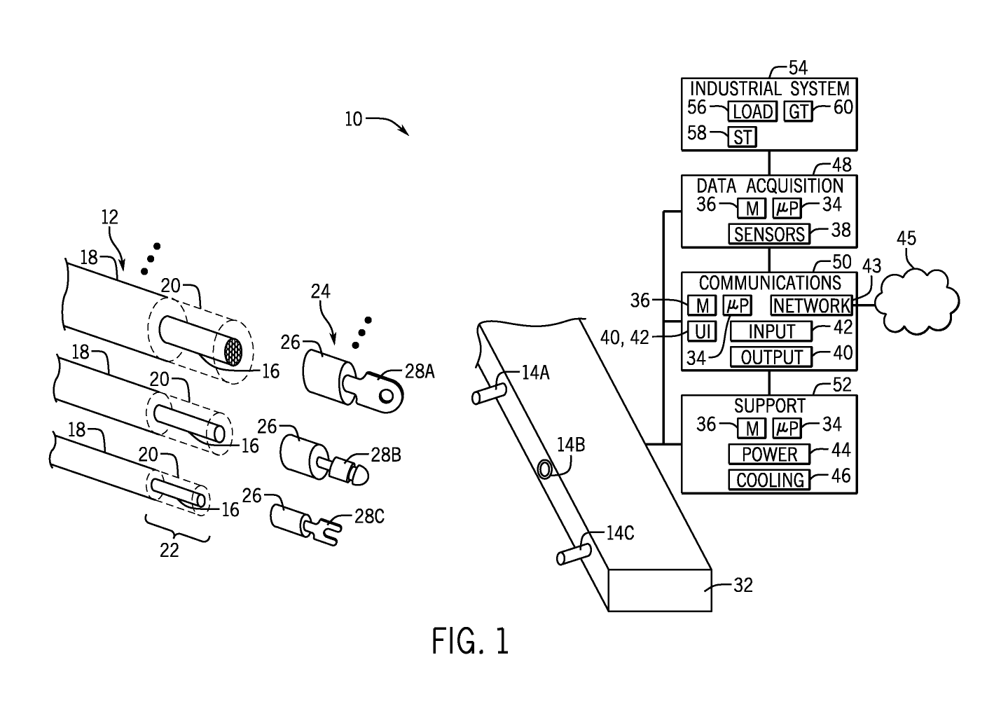

Turning to the drawings, FIG. 1 illustrates an embodiment of an electrical system 10 with multiple insulated wires 12 to be coupled to respective terminals 14. Each insulated wire 12 may have a conductor 16 at least partially surrounded by one or more layers of insulation 18. Each conductor 16 may include one or more wires. For example, the conductor 16 may be a solid wire or hollow wire, and the conductor 16 may include multiple wires in a twisted or braided arrangement. A section 20 of the insulation 18, shown by dashed lines in FIG. 1, may be removed from the insulated wire 12 to expose an end portion 22 of the conductor 16. The strip/crimp hand-tool described below may be used to cut and remove the section 20 of the insulation 18. A terminal lug 24 may be coupled (e.g., crimped) onto the exposed end portion 22 to facilitate interfacing the insulated wire 12 with the respective terminal 14. A cap 26 of a terminal lug 24 receives the end portion 22 of the conductor 16, and the cap 26 may be crimped about at least part of the exposed end portion 22. The strip/crimp hand-tool described below may be used to place and crimp the terminal lug 24 on the end portion 22.

As may be appreciated, a connection end 28 of the terminal lugs 24 may be shaped to interface with particular types of terminals 14. For example, the connection ends 28A and 28C may receive terminal prongs 14A and 14C, and the connection end 28B may be received by the terminal port 14B. At least a portion of the cap 26 and the connection end 28 are electrically conductive to transmit electrical signals and/or power between the wire 12 and the terminal 14. Each wire 12 and terminal 14 may be sized based at least in part on a type (e.g., data signal, power signal) and/or a magnitude of the electrical signal carried along the wire 12. For example, a larger diameter wire 12 may carry more current with less resistance than a smaller diameter wire 12. The strip/crimp hand-tool may be used to crimp different sizes and types of terminal lugs 24, and is not limited to any particular variety.

The terminals 14 conduct electrical signals between system components 32 of the electrical system 10. The terminals 14 may include electrical power transmission terminals, communications terminals, and so forth. The system components 32 with terminals 14 may include, but are not limited to, processors 34, memory storage devices 36, sensors 38, buses, output components 40 (e.g., displays), operator input components 42, network interfaces 43 for connection to the cloud 45 or to network of computers, electrical components (e.g., resistors, capacitors, inductors, transistors, etc.), power supplies 44, cooling systems 46, transformers, and so forth. Data acquisition systems 48, communications systems 50, and support systems 52 have system components 32 connected within the electrical system 10 by the terminals 14. In some embodiments, the data acquisition system 48 monitors and/or controls an industrial system 54. The industrial system 54 may include, but is not limited to a load 56 (e.g., electrical generator) driven by a steam turbine 58 and/or a gas turbine 60. In some embodiments, one or more of the data acquisition systems 48, one or more communications systems 50, and one or more support systems 52 may be arranged in one or more control cabinets. Among other uses, the strip/crimp hand-tool described below may be utilized to prepare insulated wires 12 for connection to terminals 14 between multiple system components 32 in control cabinets of the electrical system 10.

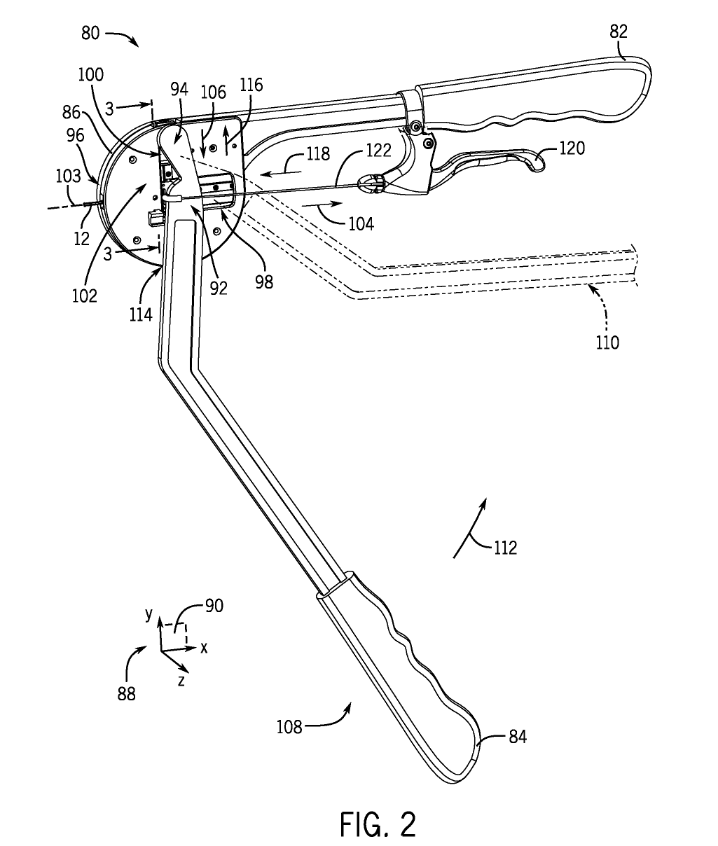

FIG. 2 illustrates an embodiment of the strip/crimp hand-tool 80 and an insulated wire 12 in a first position. The strip/crimp hand-tool 80 may have a first arm 82, a second arm 84, and a hand-tool body 86. Embodiments of the strip/crimp hand-tool 80 are described herein relative to a consistent set of coordinate axes 88. The Y-axis is the vertical direction, the X-axis is a first horizontal direction, and the Z-axis is a second horizontal direction. The strip/crimp hand-tool 80 may move primarily along an X-Y plane 90, herein referred to as a motion plane. For example, the second arm 84 is rotatably connected to the first arm 82 and to the hand-tool body 86, so that the second arm 84 rotates relative to the first arm 82 along the motion plane 90. The second arm 84 is connected to a stripping portion 92 and to a crimping portion 94. The hand-tool body 86 receives the insulated wire 12 in a wire slot 96. The stripping portion 92 moves within a first channel 98, and the crimping portion 94 moves within a second channel 100. The first channel 98 intersects the second channel 100 at a process area 102. The first channel 98, the second channel 100, and the process area 102 lie within the motion plane 90. The wire slot 96 is open to the process area 102 such that the insulated wire 12 may be inserted through the wire slot 96 into the process area 102. Within the process area 102, the stripping portion 92 cuts and removes the section 20 of insulation from the insulated wire 12, and the crimping portion 94 crimps a terminal lug 24 on the exposed end portion 22 of the conductor 16.

The stripping portion 92 and the first channel 98 are substantially parallel with the insulated wire 12 and the wire slot 96, and the crimping portion 94 and the second channel 100 are substantially perpendicular (e.g., radial) to the insulated wire 12. In some embodiments, the wire slot 96 and first channel 98 lie along the X-axis, and the second channel 100 lies along the Y-axis, as illustrated in FIG. 2. In some embodiments, the stripping portion 92 and the crimping portion 94 reciprocate along respective axes oriented between approximately 80 to 100, 70 to 110, 60 to 120, or 45 to 135 degrees relative to each other. The stripping portion 92 reciprocates along an axis substantially parallel to an axis 103 of the insulated wire 12, and the crimping portion 94 reciprocates along an axis substantially perpendicular (e.g., radial) with the axis 103 of the insulated wire 12. As used herein, the term substantially includes, but is not limited to, within approximately 10 degrees or less.

The stripping portion 92 and the crimping portion 94 are coupled to one another (e.g., via the second arm 84) such that as the stripping portion 92 moves within the first channel 98 in a first direction 104 from process area 102 along the X-axis, the crimping portion 94 moves within the second channel 100 in a second direction 106 along the Y-axis. The stripping portion 92 and the crimping portion 94 may each be fixed or rotatably coupled to the second arm 84, such that the stripping portion 92 moves in the first direction 104 and the crimping portion 94 moves in the second direction 106 as the second arm 84 moves from a first position 108 (e.g., open position) to a second position 110 (e.g., closed position) as shown by arrow 112 along the motion plane 90. That is, the stripping portion 92 moves relative to the process area 102 substantially opposite to the movement of the crimping portion 94 relative to the process area 102. As may be appreciated, in some embodiments the arrangement of the stripping portion 92 and the crimping portion 94 may be switched such that the wire slot 96 may extend through the hand-tool body 86 at location 114 along the Y-axis with the first channel 98, and the second channel 100 lies along the X-axis. When the wire slot 96 is at location 114, as the second arm 84 moves from the second position 110 to the first position 108 along the motion plane 90, the stripping portion 92 moves in a third direction 116 from the wire slot 96, and the crimping portion 94 moves in a fourth direction 118. In some embodiments, the stripping portion 92 may be coupled to the crimping portion 94 via a rotating member (e.g., knob, dial, turnkey) that rotates within the motion plane 90 (e.g., about an axis parallel to the Z-axis), thereby enabling the strip/crimp hand-tool 80 to operate without the first arm 82 and/or the second arm 84.

In some embodiments, moving the second arm 84 actuates one or more cutting blades within the stripping portion 92 to cut the section 20 of insulation 18 from the insulated wire 12. As described in detail below, the one or more cutting blades may be actuated via motion of the second arm 84 and/or a stored energy component (e.g., spring, battery). Actuating the one or more cutting blades while moving the second arm 84 may enable the operator to cut, strip, and crimp the end portion of the insulated wire 12 with substantially one continuous motion (e.g., from the first position 108 to the second position 110). Moreover, the continuous motion may be substantially within the motion plane 90, thereby decreasing the effort and complexity of movement by the operator to add the terminal lug 24. Additionally, or in the alternative, a cutting lever 120 coupled to the stripping portion 92 actuates the one or more cutting blades. The cutting lever 120 may move within the motion plane 90. In some embodiments, the cutting lever 120 may actuate the one or more cutting blades via a cable 122.

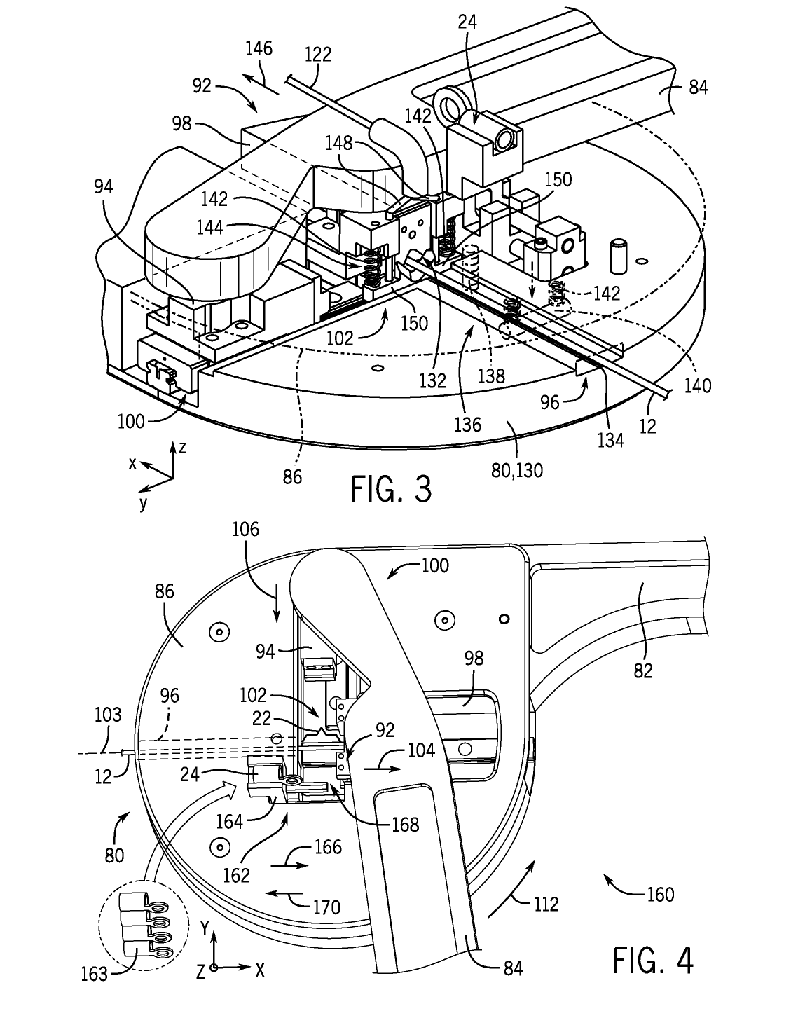

FIG. 3 illustrates an embodiment of the hand-tool body 86 and the stripping portion 92 of the strip/crimp hand-tool 80, taken along line 3-3 of FIG. 2. A top face of the hand-tool body 86 opposite the bottom face 130 is not shown in order to better show the embodiment of the one or more cutting blades 132 of the stripping portion 92. The insulated wire 12 is inserted through the wire slot 96 into the process area 102. In some embodiments, the wire slot 96 includes a groove 134 to aid centering the insulated wire 12 within the one or more cutting blades 132. A wire retention system 136 may engage the insulated wire 12 within the wire slot 96, thereby restricting movement of the insulated wire 12 along the Z-axis. In some embodiments, the wire retention system 136 includes one or more set screws 138 through the top face or the bottom face 130 that forces the insulated wire 12 against the groove 134. Additionally, or in the alternative, one or more rollers 140 may engage the insulated wire 12 within the wire slot 96 along the Z-axis and/or the Y-axis. The one or more rollers 140 may be biased to exert a force against the insulated wire 12, such as via one or more springs 142. In some embodiments, the wire retention system 136 may be engaged by an operator via a lever similar to the cutting lever 120 shown in FIG. 2 or by movement of the second arm 84 from the first position 108 to the second position 110.

The stripping portion 92 may have a stop 144 that interfaces with the end portion 22 of the insulated wire 12 and positions the one or more cutting blades 132 to cut the section 20 of insulation 18 at a desired length. In some embodiments, the stop 144 is adjustable along the X-axis to accommodate terminal lugs 24 of various sizes. The one or more cutting blades 132 may actuate along an axis substantially perpendicular (e.g., radial) to the insulated wire 12, thereby cutting the section 20 of insulation 18 to a cut depth. One cutting blade 132 may move along the Z-axis to cut the section 20 of insulation 18 from the insulated wire 12. In some embodiments, two or more cutting blades 132 may converge on the insulated wire 12. Converging cutting blades 132 may enable the section 20 of insulation 18 to be cut without bending the insulated wire 12. Multiple cutting blades 132 may be used to cut around substantially the entire circumference of the section 20 of insulation 18. In some embodiments, the one or more cutting blades 132 are biased with one or more springs 142 to a default open position. For example, actuating the cutting lever 120 may pull the cable 122 along the X-axis as shown by arrow 146, thereby actuating the one or more cutting blades 132 by the blade cables 148.

In some embodiments, the one or more cutting blades 132 are coupled to the wire retention system 136, such that the cutting depth is based at least in part on the wire size determined by the wire retention system 136. Blade stops 150 coupled to the one or more cutting blades 132 may be adjusted based at least in part on a position of the set screw 138, the roller 140, the spring 142, or other component of the wire retention system 136. As may be appreciated, the cutting depth may be otherwise adjusted by controlling the travel of the cable 122 and/or blade cable 148 based on a position of a component of the wire retention system 136. By setting the cut depth based at least in part on the wire size, the one or more cutting blades 132 may cut through substantially the entire section 20 of insulation about the conductor 16 without cutting or abrading the surface of the conductor 16.

FIG. 4 illustrates a front view of the strip/crimp hand-tool 80 in an intermediate position 160 in which the section 20 of insulation 18 has been cut and removed from the insulated wire 12, and the terminal lug has not yet been positioned and crimped onto the exposed end portion 22 of the conductor 16. As the second arm 84 moves towards first arm 82 as shown by arrow 112, the stripping portion 92 moves in the first direction 104 in the first channel 98, removing the cut section 20 of insulation 18 from the insulated wire 12. As discussed above, the wire retention system 136 retains the insulated wire 12 so that the stripping portion 92 removes only the cut section 20 of the insulation while the end portion 22 remains within the process area 102. After the stripping portion 92 removes the section 20 of insulation 18, the terminal lug 24 may be positioned about the exposed end portion 22 of the conductor 16. The operator may manually place the terminal lug 24 about the end portion 22 prior to moving the crimping portion 94 in the second direction 106 (e.g., via moving the second arm 84 in direction 112) to crimp the terminal lug 24. In some embodiments, a lug loading system 162 positions the terminal lug 24 about the end portion 22.

The lug loading system 162 may be manually actuated by the operator, or actuated automatically while the operator moves the stripping portion 92 and the crimping portion 94. In some embodiments, a loading arm 164 with a terminal lug 24 moves in direction 166 along the X-axis up to or past the end portion 22 of the conductor 16. A loading slot 168 facilitates rotation of the loading arm 164 and terminal lug 24 to align the terminal lug 24 with the end portion 22 of the conductor 16. Once aligned with the end portion 22, the loading arm 164 may be moved in direction 170 (e.g., axial direction relative to the insulated wire 12) along the X-axis, thereby positioning the terminal lug 24 about the end portion 22. In some embodiments, the lug loading system 162 may position the terminal lug about the end portion from a radial direction (e.g., along the Z-axis) relative to the insulated wire 12.

In some embodiments, the lug loading system 162 receives a lug magazine 163 with multiple terminal lugs 24, thereby enabling the strip/crimp hand-tool 80 to crimp multiple terminal lugs 24 on multiple respective conductors 16 before reloading the lug loading system 162 with additional terminal lugs 24 (e.g., via replacement of the lug magazine). A lug magazine 163 may include multiple terminal lugs 24 coupled together via respective terminal caps 26 and/or respective connection ends 28. The lug loading system 162 may separate a terminal lug 24 of the lug magazine 163 from other terminal lugs 24 to arrange the terminal lug 24 about the end portion 22.

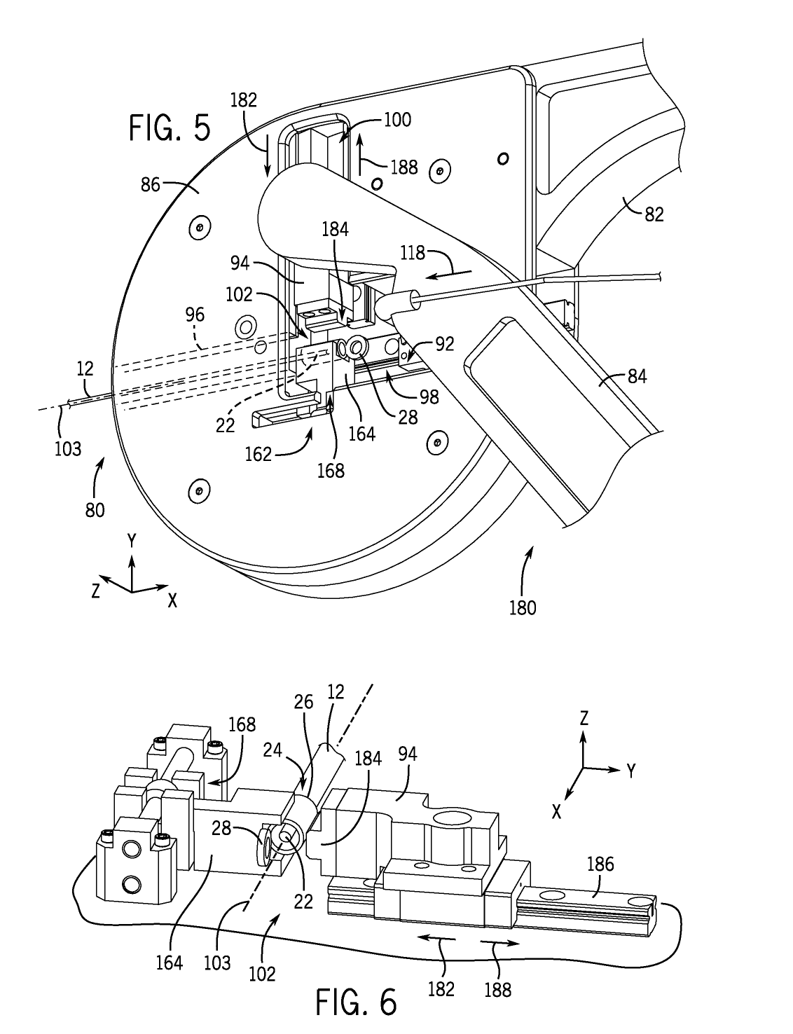

FIG. 5 illustrates a perspective view of an embodiment of the strip/crimp tool 80 in an intermediate position 180 in which the terminal lug 24 is about the end portion 22 of the conductor 16, and the operator may operate the strip/crimp tool 80 to crimp the terminal lug 24 on the insulated wire 12. Actuating the second arm 84 moves the crimping portion 92, as shown by arrow 182, within the second channel 100 towards the end portion 22 and the terminal lug 24 in the process area 102. A crimping face 184 of the crimping portion 94 is configured to interface with the cap portion 26 of the terminal lug 24. The crimping portion 94 converts operator force on the second arm 84 to a force from the crimping face 184 on the cap portion 26, mechanically coupling the cap portion 26 to the end portion 22. As may be appreciated, the force on the cap portion 26 from the crimping face 184 causes the cap portion 26 to yield and collapse (e.g., crimp) about the end portion 22.

FIG. 6 illustrates a perspective view of the crimping portion 94 and the terminal lug 24 about the end portion 22. In some embodiments, movement of the second arm 84 may reciprocate the crimping portion 94 within the second channel 100 along a crimping guide 186 (e.g., axial rail). The crimping portion 94 moves in direction 182 to crimp the terminal cap 26 of the terminal lug 24 about the end portion 22, and the crimping portion 94 moves in direction 188 to facilitate removal of the crimped terminal lug 24 and insulated wire 12, and insertion of another insulated wire 12. The crimping face 184 may be complementary to the loading arm 164, thereby enabling the crimping portion 94 to crimp the terminal cap 24 substantially about the circumference of the end portion 22.

Returning to FIG. 5, the insulated wire 12 with the crimped terminal lug 24 may be removed through the wire slot 96 after the crimping face 184 interfaces (e.g., crimps) with the terminal lug 24. Upon removal of the insulated wire 12, the strip/crimp hand-tool 80 may be reset to enable cutting, stripping, and crimping of another insulated wire 12. To reset the strip/crimp hand-tool 80, the second arm 84 moves to the first position 108, thereby moving the crimping portion 94 in direction 188 from the process area 102 in the second channel 100 and moving the stripping portion 92 in direction 118 to the process area 102 in the first channel 98. In some embodiments, the stripping portion 92 moving in direction 118 ejects the insulated wire 12 and crimped terminal lug 24 through the wire slot 96. In some embodiments, the operator manually resets the lug loading system 162 separately from moving the second arm 84.

In some embodiments, the lug loading system 162 and/or the one or more cutting blades 132 are coupled to the second arm 84 and actuated by movement of the second arm 84. For example, the lug loading system 162 may be coupled to the second arm 84 such that resetting the second arm 84 to the first position 108 automatically removes the loading arm 164 or other lug loading system 162 component from the process area 102. In some embodiments, springs 142 coupled to the one or more cutting blades 132 are biased (e.g., loaded) by resetting the strip/crimp hand tool 80 to the first position 108, enabling the one or more cutting blades 132 to automatically cut the section 20 of insulation 18 of another insulated wire 12 as the second arm 84 moves to the second position 110. As may be appreciated, components coupling the lug loading system 162 and/or the one or more cutting blades 132 to the second arm 84 may include, but are not limited to, springs 142, pulleys, cams, geared linkages, or any combination thereof.

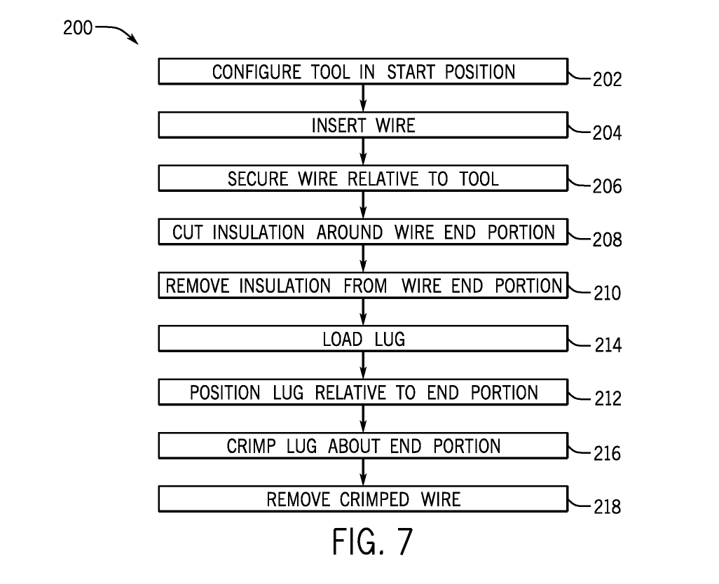

FIG. 7 illustrates an embodiment of a method 200 for utilizing the strip/crimp hand-tool 80 to strip an end portion 22 of an insulated wire 12 and crimp a terminal lug 24 about the end portion 22. An operator configures (block 202) the strip/crimp hand-tool in a starting position (e.g., first position 108). The orientation of the first and second arms 82, 84 may be based at least in part on the orientation of the stripping portion 92 and the crimping portion 94 within the respective first and second channels 98, 100. For example, as shown in FIG. 2, the second arm 82 may be opened to the first position 108, thereby positioning the stripping portion 92 in the process area 102 and moving the crimping portion 94 from the process area 102. The operator inserts (block 204) an insulated wire 12 through the wire slot such that the end portion 22 of the insulated wire 12 extends into the process area 102 of the strip/crimp hand-tool 80.

The insulated wire 12 may be secured (block 206) to the strip/crimp hand-tool 80 by a wire retention system 136. As may be appreciated, securing the insulated wire 12 may aid removal of the section 20 of insulation 18 from the insulated wire 12. One or more cutting blades 132 cut (block 208) a section 20 of insulation 18 around the end portion 22 of the conductor 16. As described above, the one or more cutting blades 132 are coupled to the stripping portion 94. The one or more cutting blades 132 may be actuated by movement of the second arm 84 and/or a cutting lever 120. In some embodiments, the cut depth 132 of the one or more cutting blades 132 is based at least in part on a size or gauge of the insulated wire 12 as determined by the wire retention system 136. Upon cutting the section 20 of insulation 18 with the one or more cutting blades 132, movement of the second arm 84 towards the ending position (e.g., second position 110) reciprocates the coupled stripping portion 94 within the first channel 98 to remove (block 210) the section 20 of insulation 18 from the end portion 22 of the insulated wire 12.

In some embodiments, the operator loads (block 214) each terminal lug 24 in the lug loading system 162 prior to positioning (block 212) the terminal lug 24 about the end portion 22. Upon removal (e.g., stripping) of the section 20 of insulation 18, the operator positions (block 212) a terminal lug 24 about the exposed end portion 22 of the conductor 16. The terminal lug 24 may be positioned manually or automatically via a lug loading system 162. The terminal lug 24 may be loaded (block 214) into the lug loading system 162 at different times, including but not limited to after a previous terminal lug 24 is crimped onto the end portion 22 via an automatic lug loading system 162 or during any of the actions of blocks 202-210. The lug loading system 162 may be coupled to the second arm 84 and actuated to position (block 212) the terminal lug 24 via movement of the second arm 84 to the ending position 110. After the terminal lug 24 is positioned about the end portion 22, the crimping portion 94 of the strip/crimp hand-tool 80 reciprocates within the second channel 100 toward the process area 102 to crimp (block 216) the terminal lug 24 about the end portion 22. In some embodiments, each terminal lug 24 in the lug loading system 162 is loaded prior to one of the blocks 202-210. For example, a subsequent terminal lug from a lug magazine may be loaded into the lug loading system immediately after a prior terminal lug is positioned (block 212) or crimped (block 216) about the end portion of an insulated wire. As may be appreciated in view of the above description and FIGS. 2-6, the actions of blocks 206-216 may be initiated by actuating the second arm 84 to the end position 110 from the starting position 108. Additionally, or in the alternative, the stripping portion 92 and the crimping portion 94 may be actuated by a knob or other member. After the terminal lug 24 is crimped, the operator may remove (block 218) the crimped wire from the strip/crimp hand-tool 80. In some embodiments, the strip/crimp hand-tool 80 may eject the insulated wire 12 and crimped terminal lug 24 when the method 200 restarts by configuring (block 202) the strip/crimp hand-tool 80 in the start position 108. The strip/crimp hand-tool 80 may eject the crimped wire after the crimping portion 94 crimps (block 216) the terminal lug 24.

A lug magazine 163 and an automated lug loading system 162 may increase the speed at which the operator may crimp terminal lugs 24 about multiple insulated wires 12. The strip/crimp hand-tool 80 may enable an operator to strip an insulated wire 12 and to crimp a terminal lug 24 about the end portion 22 in less than approximately 30, 15, 10, or 5 seconds. The lug magazine 163 and lug loading system 162 may enable the operator to strip multiple (e.g., 2, 3, 4, 5, 6, 7, 8, 9, 10 or more) insulated wires 12 and to crimp multiple respective terminal lugs 24 about the corresponding end portions 22 without stopping to reload the terminal lugs 24. For example, the strip/crimp hand-tool 80 may enable an operator to strip an insulated wire 12 and to crimp a respective terminal lug 24 about the end portion 22 in approximately 10 seconds, and the lug magazine 163 may enable the operator to strip approximately 4 to 6 insulated wires 12 and to crimp respective terminal lugs 24 about the corresponding end portions 22 of the 4 to 6 insulated wires 12 within approximately 1 minute without manually reloading additional terminal lugs 24.

As described above, the strip/crimp hand-tool enables an operator to strip an end portion of an insulated wire and to crimp a terminal lug about the end portion in substantially one motion along a motion plane. The strip/crimp hand-tool enables the operator to strip and crimp an insulated wire without utilizing multiple separate tools (e.g., stripping tool, crimping tool) and/or without manual repositioning of the wire relative to the hand-tool, such as to reposition the wire after removal of the insulation and prior to crimping the terminal lug. Accordingly, the strip/crimp hand-tool may increase the speed at which an operator may process (e.g., strip and crimp) multiple insulated wires. For example, the strip/crimp hand-tool may enable the operator to process an insulated wire in less than approximately 15 seconds. Reducing the time to process an insulated wire for connection to a terminal may substantially reduce labor costs for projects involving hundreds or thousands of terminals for connecting with crimped terminal lugs on insulated wires. The strip/crimp hand-tool may also reduce the quantity of operator actions on the hand-tool to process the insulated wire. In some embodiments, one or more processes (e.g., actuating the one or more cutting blades, loading subsequent terminal lugs within the lug loading system) may be at least partially automated to be performed as the operator actuates the stripping portion and the crimping portion within the motion plane.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system comprising:
a tool comprising:
a hand-tool body comprising a wire slot, a first channel, and a second channel, wherein the wire slot, the first channel, and the second channel are within a motion plane and intersect at a process area, and the wire slot is configured to receive an insulated wire;
a stripping portion arranged within the first channel, wherein the stripping portion is configured to reciprocate along the first channel to strip insulation from an end portion of the insulated wire; and
a crimping portion coupled to the stripping portion and arranged within the second channel, wherein the crimping portion is configured to reciprocate along the second channel to crimp a terminal lug about at least part of the end portion of the insulated wire, and the reciprocation of the stripping portion along the first channel relative to the process area is substantially opposite to the reciprocation of the crimping portion along the second channel.

2. The system of claim 1, comprising a first arm coupled to the hand-tool body, and a second arm coupled to the stripping portion and to the crimping portion, wherein rotation of the second arm relative to the first arm within the motion plane is configured to reciprocate the stripping portion within the first channel and to reciprocate the crimping portion within the second channel.

3. The system of claim 1, wherein the stripping portion comprises a cutting portion comprising one or more blades configured to cut insulation at the end portion of the insulated wire.

4. The system of claim 3, comprising a cutting lever configured to actuate the one or more blades to cut insulation at the end portion.

5. The system of claim 1, comprising a lug loading system coupled to the hand-tool body, wherein the lug loading system is configured to place the terminal lug about the end portion of the insulated wire after insulation is stripped from the end portion.

6. The system of claim 5, wherein the lug loading system comprises a lug magazine, and the terminal lug placed by the lug loading system is configured to be removed from the lug magazine as the crimping portion reciprocates toward the process area.

7. A system comprising:
a tool comprising:
a first arm disposed along a motion plane;
a hand-tool body coupled to the first arm, wherein the hand-tool body comprises a first channel, a second channel, and a wire slot configured to receive an insulated wire, wherein the first channel intersects the second channel proximate to the wire slot; and
a second arm rotatably coupled to the hand-tool body and disposed along the motion plane, wherein the second arm comprises:
a stripping portion configured to reciprocate within the first channel, to cut insulation of the insulated wire, and to strip the insulation from an end portion of the insulated wire; and
a crimping portion configured to reciprocate within the second channel and to crimp a terminal lug about the end portion of the insulated wire.

8. The system of claim 7, wherein the stripping portion comprises one or more blades configured to cut the insulation of the insulated wire when the second arm rotates along the motion plane.

9. The system of claim 7, comprising a cutting lever coupled to the stripping portion along the motion plane, wherein the stripping portion comprises one or more blades and the cutting lever is configured to actuate the one or more blades to cut the insulation when the cutting lever actuates along the motion plane.

10. The system of claim 7, comprising a lug loading system coupled to the hand-tool body, wherein the lug loading system is configured to load a terminal lug on the end portion of the insulated wire after the insulation is stripped.

11. The system of claim 10, wherein the lug loading system is configured to load the terminal lug on the end portion of the insulated wire automatically when the second arm is actuated along the motion plane.

12. The system of claim 7, comprising a wire retention system configured to hold the end portion of the insulated wire relative to the hand-tool body while the second arm rotates along the motion plane.

13. The system of claim 7, wherein the stripping portion is configured to cut the insulation at a cut depth based at least in part on a size of the insulated wire.

14. A method, comprising:
rotating a second arm of a hand-tool relative to a first arm of the hand-tool from a first position to a second position within a motion plane;
cutting insulation from an end of an insulated wire with a stripping portion of the hand-tool;
removing insulation from the end of the insulated wire with the stripping portion of the hand-tool, wherein the stripping portion is actuated along the motion plane by the second arm to remove insulation;
arranging a terminal lug about the end of the insulated wire; and
crimping the terminal lug about the end of the insulated wire with a crimping portion of the hand-tool, wherein the crimping portion is actuated along the motion plane by the second arm.

15. The method of claim 14, comprising:
resetting the second arm of the hand-tool to the first position within the motion plane, wherein resetting the second arm is configured to eject the insulated wire and the crimped terminal lug from the hand-tool.

16. The method of claim 14, comprising actuating a cutting lever coupled to the stripping portion of the hand-tool to cut the insulation of the insulated wire.

17. The method of claim 14, wherein cutting the insulation comprises cutting the insulation to a cut depth based at least in part on a size of the insulated wire.

18. The method of claim 14, wherein the hand-tool comprises a lug loading system, wherein arranging the terminal lug about the end of the insulated wire comprises arranging the terminal lug on the end of the insulated wire automatically with the lug loading system of the hand-tool when the second arm is actuated along the motion plane.

19. The method of claim 18, wherein the lug loading system comprises a lug magazine comprising a plurality of terminal lugs.

20. The method of claim 14, wherein the second arm is rotated substantially continuously from the first position to the second position, wherein the hand-tool is configured to remove insulation and crimp the terminal lug by rotating the second arm relative to the first arm along the motion plane.
